(19) United States
(12) Patent Application Publication
(10) Pub. No.: US 2014/0229816 A1
(43) Pub. Date: Aug. 14, 2014

(54) METHODS AND DEVICES FOR TAGGING A DOCUMENT

(71) Applicant: Syed Imtiaz Yakub, New York, NY (US)

(72) Inventor: Syed Imtiaz Yakub, New York, NY (US)

(21) Appl. No.: 13/762,456

(22) Filed: Feb. 8, 2013

(51) Int. Cl. G06F 17/24

(52) U.S. Cl. CPC G06F 17/241
USPC 715/230

(57) ABSTRACT

Methods and devices for tagging a document are described. In one aspect, a method includes: receiving, via an input interface, an instruction to select a first section of first content within a first document; and tagging the selected first section of the first content with a first key term.

### TECHNICAL FIELD

The present application relates to document management and more particularly to methods and devices for tagging a document.

### BACKGROUND

Electronic devices such as laptops, desktops and tablet computers are often equipped with an application to manage documents. For example, a word processor application may allow a user to compose, edit, format, print, display and store documents. The word processor application may, for example, allow a user to manipulate the content of a document by removing portions of the content, changing the graphics of the content, incorporate content from another document, etc.

A word processor application, however, does not provide a user with an easy way of managing relevant content within a document. For example, a user may desire to note relevant content within a document for future reference. In such cases, a user may have to graphically alter the relevant section of the content (for example, by highlighting the section) and/or copy and paste the section in a new document. This can be a cumbersome and inefficient process for a user.

### BRIEF DESCRIPTION OF THE DRAWINGS

Reference will now be made, by way of example, to the accompanying drawings which show example embodiments of the present application, and in which:

FIG. 1 is a block diagram illustrating an example electronic device in accordance with example embodiments of the present disclosure;

FIG. 2 is a flowchart illustrating an example method of tagging a document in accordance with example embodiments of the present disclosure;

FIG. 3 is a flowchart illustrating another example method of tagging a document in accordance with example embodiments of the present disclosure;

FIG. 4 is an example display page of a document on a display of the example electronic device in accordance with example embodiments of the present disclosure;

FIG. 5 is another example display page of another document on the display of the example electronic device in accordance with example embodiments of the present disclosure.

Like reference numerals are used in the drawings to denote like elements and features.

### DETAILED DESCRIPTION

In one aspect, the present application describes a method implemented by a processor of an electronic device. The electronic device includes an input interface. The method includes: receiving, via the input interface, an instruction to select a first section of first content within a first document; and tagging the selected first section of the first content with a first key term.

In another aspect, the present application describes an electronic device. The electronic device includes an input interface, a memory and a processor coupled to the input interface and memory. The processor is configured to: receive, via the input interface, an instruction to select a first section of first content within a first document; and tag the selected first section of the first content with a first key term.

In yet another aspect, the present application describes a computer readable storage medium. The computer readable storage medium stores computer executable instructions. The computer executable instructions include instructions for: receiving, via an input interface, an instruction to select a first section of first content within a first document; and tagging the selected first section of the first content with a first key term.

Other example embodiments of the present application will be apparent to those of ordinary skill in the art from a review of the following detailed description in conjunction with the drawings.

### Example Electronic Device

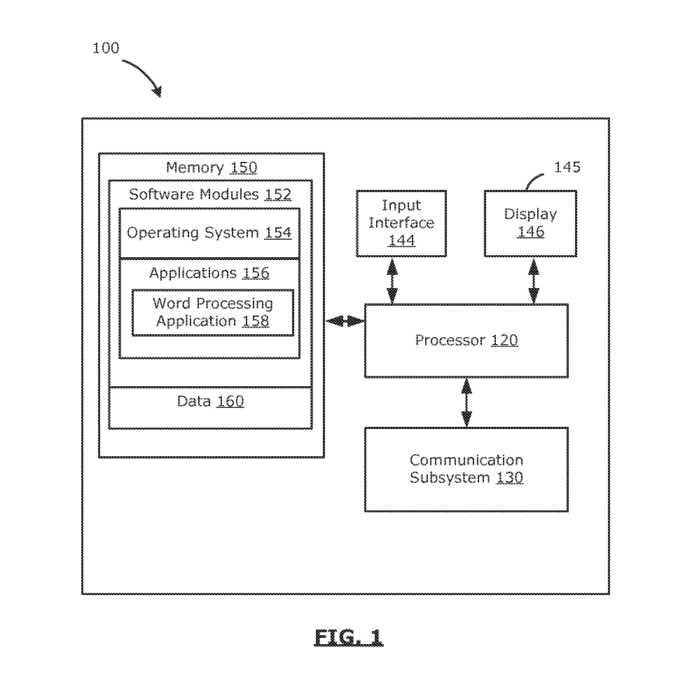

Reference is first made to FIG. 1 which shows in block diagram form an example electronic device 100 in which example embodiments of the present disclosure can be applied. The electronic device 100 may be of a variety of different types. For example, in at least some example embodiments, the electronic device 100 is a desktop or a laptop style computer (such as a notebook or a netbook). In other example embodiments, the electronic device 100 is a tablet style computer. In further example embodiments, the electronic device 100 is a mobile communication device such as a smartphone or other style mobile communication device. The electronic device 100 may be of other types not specifically listed herein.

The electronic device 100 includes a controller which may include one or more processors 120 that control the overall operation of the electronic device 100. The processor 120 may be communicably coupled with device subsystems including one or more input interfaces 144 (such as a keyboard, control buttons, a mouse, a microphone, a touch-sensitive overlay associated with a touchscreen display, a mouse, a trackpad, a microphone and/or other input interfaces), one or more output interfaces 145 (such as a display 146 and/or a speaker), memory (which may include multiple memory components of various types such as flash memory, random access memory (RAM), read only memory (ROM), a hard disk drive (HDD), a solid state drive (SSD), or other types of memory), and a communication subsystem 130 for communicating either wirelessly or non-wirelessly with other systems, servers and/or electronic devices. The processor 120 may be communicably coupled with other device subsystems not specifically described herein.

The processor 120 operates under stored program control and executes software modules 152 stored in memory 150. As illustrated in FIG. 1, the software modules 152 may include operating system 154 software and one or more additional software applications 156 such as a word processor application 158.

The operating system 154 is software that manages the electronic device 100 components (such as the display 146, input interface 144, communication subsystem 130, etc.) and provides a platform for software applications 156. The operating system 154 also acts as an intermediary between the electronic device 100 components and the software applications 156. For example, the operating system 154 may recognize data that is being input from an input device and route the inputted data to be executed by a software application 156. The operating system 154 may be Microsoft Windows OS™, iOS™, Linux™, UNIX™, Android™ or any other operating system 154 having the necessary capabilities for implementing the functions described herein.

The word processor application 158 is an application that allows for document management. For example, the word processor application 158 allows for documents to be created, edited, formatted, displayed and stored. The word processor application 158 may allow for varying the content of a document. For example, portions of the content of a document may be removed, graphically altered, etc. In at least some example embodiments, the word processor application 158 may allow a user to change document properties by, for example, allowing a document to be merged with another document, changing the format of a document, etc. It will be appreciated that the word processor application 158 may provide additional document management features and functions not specifically described herein.

In at least some example embodiments, the word processor application 158 may be configured to receive an instruction via the input interface 144 associated with the electronic device 100 to select a first section of first content within a first document. For example, a user may provide a command via an input device (such as a mouse) to select a portion of the content within the first document. The word processor application 158 may then tag the selected first section of the first content with a first key term. That is, a key term (which may be user-defined and may include any types of words and/or phrases) is assigned as a label to the selected first section. In at least some example embodiments, multiple sections of the first content within the first document may be selected (via the input interface 144) and tagged with the first key term. For example, a second section of the first content data may be additionally selected and tagged with the first key term. In such example embodiments, the word processor application 158 may then populate a first summary document with all the tagged content (such as, the first section and the second section) based on the first key term. That is, a different document is populated to include all the content that is associated with first key term.

In at least some example embodiments, the selection and tagging may be performed for multiple documents. For example, the word processor application 158 may receive an instruction via the input interface 144 to select a third section of second content within a second document. The word processor application 158 may then tag the selected third section of the second content with the first key term. In such example embodiments, the word processor application 158 may then populate the first summary document with the first section, the second section and the third section based on the first key term.

In at least some example embodiments, the selection and tagging may be performed for multiple different key terms. For example, after receiving a selection of the second section of the first content within the first document, the word processor application 158 may, instead, tag the selected section with a second key term. In such example embodiments, the word processor application 158 may then populate a second summary document with the second section based on the second key term. Additionally, in at least some example embodiments, a fourth section of the second content within the second document may also be selected, and tagged with the second key term. In such example embodiments, the word processor application 158 may then populate the second summary document with the section and the fourth section based on the second key term.

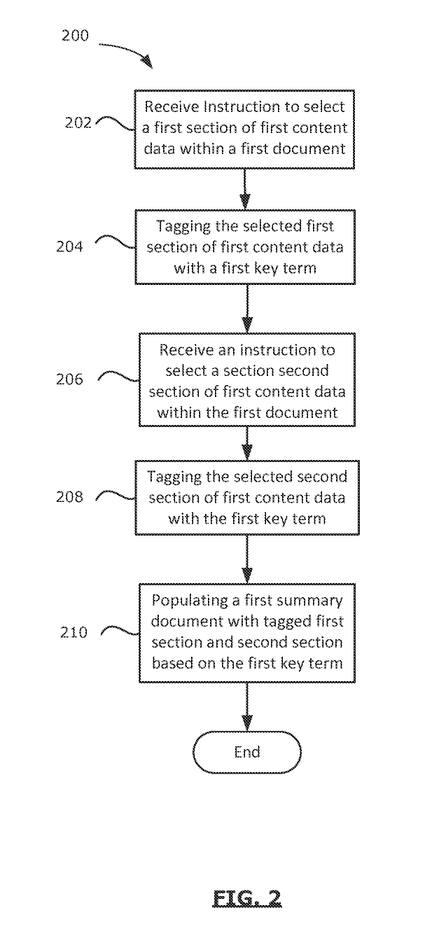

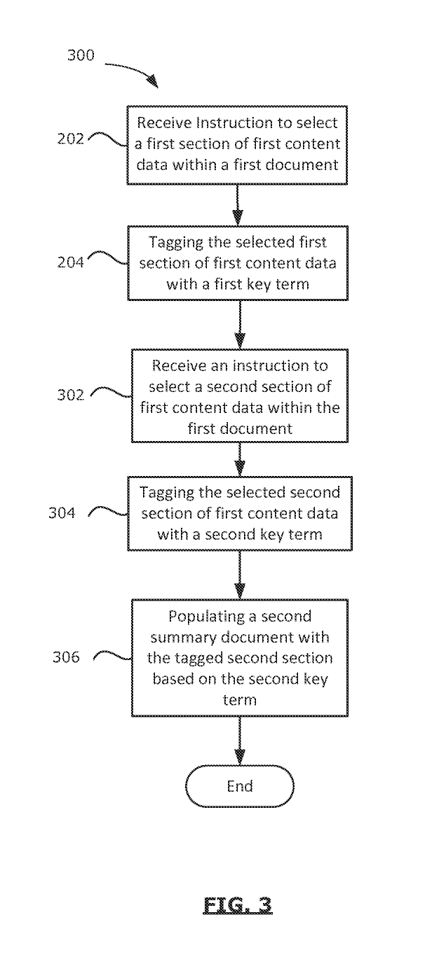

Greater details of the functions and features of the word processor application 158 will be provided below with reference to FIGS. 2 and 3.

The memory 150 of the electronic device 100 may also store a range of additional applications including, for example, internet browser application, email application, media player application, spreadsheet application, image editing application, etc. Each of these software applications 156 may be retrieved and accessed to perform associated functions according to the application 156.

The memory 150 also stores data 160 of various types. For example, in at least some example embodiments, the data 160 includes service data to establish and maintain connection with a wireless network. The data 160 may also include user application data such as email messages, address book and contact information, image data, calendar and schedule information, notepad documents, image files, and other commonly stored user information stored on the electronic device 201 by its user. The memory 150 may also include other data 160 not specifically described herein.

As mentioned above, the electronic device 100 may include one or more input interfaces 144. The input interfaces 144 are configured to input instructions and commands to the electronic device 100 to perform particular tasks and functions. For example, a user may input instructions to select one or more sections of content within documents. The electronic device 100 may also include a display 146. The display 146 may be configured to display documents including the first and second documents, and the first and second summary documents. The input interfaces 144 and the display 146 may be internal (i.e. built-in) and/or external (i.e. separate) components associated with the electronic device 100. The input interfaces 144 and the display 146 may also be controlled by the processor 120. The electronic device 100 may also include one or more communication subsystems to connect with other systems, server and/or electronic devices both wirelessly (for example, WiFi connection, Bluetooth connection, etc.) and non-wirelessly (for example, USB connection, ethernet connection, etc.).

In at least some example embodiments, the operating system 154 may perform some or all of the functions of the word processor application 158. In other example embodiments, the functions or a portion of the functions of the word processor application 158 may be performed by one or more other applications. For example, in at least some example embodiments, the populating function may be performed by one or more other applications.

Further, while the word processor application 158 has been illustrated as a stand-alone application, in other example embodiments, the word processor application 158 may be implemented as part of the operating system 154 or another application 156. Furthermore, in at least some example embodiments, the functions of the word processor application 158 may be provided by a plurality of software modules. In at least some example embodiments, these software modules may be divided among multiple applications.

### Tagging a Document

Referring now to FIG. 2, a flowchart of an example method 200 of tagging a document is illustrated. The electronic device 100 may be configured to perform the method 200 of FIG. 2. In at least some example embodiments, the processor 120 of the electronic device 100 may be configured to perform the method 200 of FIG. 2. One or more applications 156 or modules on the electronic device 100 may contain computer readable instructions which cause the processor 120 of the electronic device 201 to perform the method 200 of FIG. 2. In at least some example embodiments, the word processor application 158 stored in memory 150 of the electronic device 100 is configured to perform the method 200 of FIG. 2. More specifically, the word processor application 158 may contain computer readable instructions which, when executed, cause the processor 120 to perform the method 200 of FIG. 2.

It will be appreciated that the method 200 of FIG. 2 may, in at least some example embodiments, be fully or partially provided by other software applications or modules apart from those specifically discussed above, such as, the operating system 223. Accordingly, any features which are referred to as being performed by the electronic device 201 may be performed by any one or more of the software applications 225 or modules referred to above or other software modules.

The method 200, includes at 202, receiving, via an input interface 144, an instruction to select a first section of first content within a first document. That is, a portion of content included in a first document is selected. The content within the first document may include any type of data such as alphanumeric data, symbol data, image data, chart data, graphics data, etc. As such, a portion of any of these types of data or a combination of any the types of data within the first document may be selected. For example, a selected section may include alphanumeric data, a chart and/or an image.

The document may be any type of electronic document capable of including content. For example, the document may be a word document (e.g. .doc, .docx), a notepad document (.txt), a rich text format document (.rtf), a portable document format (.pdf), an extensible markup document (.xml), a HyperText Markup Language (html) document, etc. It will be appreciated that the document may be of other types not specifically described herein. Additionally, the type of document may depend upon the application 156 the document is associated with (for example, the document may define an email message for an email application, a webpage for a social media application, etc.). In at least some example embodiments, the first document may be stored on the electronic device 100 (for example, in the memory 150 of the electronic device 100). In at least some example embodiments, the first document may not be stored on the electronic device 100. In such example embodiments, the first document may be stored in another electronic device, system and/or server, and may be retrieved by the electronic device 100 for selection of a first section of first content data within the first document.

In at least some example embodiments, the selection of the first section of the first content may graphically alter the first section. That is, the selected first section may have different features than when not selected. For example, the selected section may have a change in color effect, a darkening effect, a highlighting effect, an underlining effect, a stylistic effect, etc. For example, the alphanumeric characters within a first section may be highlighted when selected. The change in the graphics of a section may indicate that the section has been selected.

The instruction to select the first section of the first content data within the first document may be received from an input interface 144 associated with the electronic device 201. For example, the instruction may be received from a keyboard, a mouse, a touchscreen, a trackpad and/or other input interfaces 144. A user may select a first section of first content within a first document by inputting a command via one of more of these input interfaces 144.

After receiving the instruction, the electronic device 100, at 204, may tag the selected first section of the first content with a first key term. That is, the selected first section is assigned the first key term as a label. In at least some example embodiments, when tagging the selected first section, the first key term is associated with the first section as metadata. Metadata is data that may describe and provide information about other data. Accordingly, the key term may be metadata defining the selected first section.

In at least some example embodiments, the key term metadata may be stored as part of the document (i.e. the key term metadata may be stored internally). That is, the key term metadata may be stored embedded within the document. In at least some example embodiments, the key term metadata may not be stored as part of the document (i.e. the key term metadata may be stored externally). For example, the key term metadata may be stored as separate data within the memory 150 of the electronic device 100. The key term metadata stored as separate data may be accessed by one or more applications such as the word processor application 158.

The first key term may be any type of word and/or phrase that is tagged with the selected first term. In at least some example embodiments, the first key term may include alphanumeric characters and/or symbols. The first key term may or may not be included within the first section of the first content data within the first document. For example, the first key term may be the phrase “Cause of Action A” which may or may not be included within the selected first section.

In at least some example embodiment, the electronic device 100 may automatically define the first key term to tag the selected first section. For example, the first key term may be defined by the electronic device 100 based on a word or phrase within the selected first section. The electronic device 100 may examine the content within the first section and use a word or a phrase within the first section as the first key term. However, in at least some example embodiments, a user may define the first key term. That is, prior to tagging the selected first section, the first key term is received via an input interface associated with the electronic device. For example, a user may input the first key term from a keyboard, a touchscreen, a mouse, a trackpad and/or other input interfaces 144 associated with the electronic device 100. In at least some example embodiments, prior to tagging the selected first section, the electronic device 100 may present a request to input a first key term for the selected first section via an output interface 145 (such as the display 146) associated with the electronic device 100. Accordingly, a user may input the first key term which is received by the electronic device 100.

In at least some example embodiments, the electronic device 100 may automatically tag the selected first section of the first content within the first document with the first key term. That is, the selected first section is tagged without the need for further user input from a user. However, in at least example embodiments, further user input is required from a user via an input interface 144 associated with the electronic device 100 in order to tag the selected first section. For example, after the first section is selected (and prior to tagging), a prompt may be presented via an output interface 145 (such as a display 146) associated with the electronic device 100 to request confirmation to tag the first section with the first key term. When confirmation is received by a user via an input interface 144 (such as a keyboard, a touchscreen, a mouse, a trackpad and/or other input interfaces 144) associated with the electronic device 100, the first section is tagged with the first key term.

At 206, the electronic device 100 may receive, via an input interface 144, an instruction to select a second section of the first content within the first document. That is, the electronic device 100 receives a command to select a different section than the first section of the first content within the first document. It will be appreciated that the selection of 206 may be performed in the same manner as 202 which is discussed above.

In response to receiving the instruction, the electronic device 100, at 208, may tag the selected second section of the first content with the first key term. That is, the selected second section is additionally assigned the first key term as a label. It will be appreciated that the tagging of 208 may be performed in the same manner as 204 discussed which is discussed above.

In at least some example embodiments, the electronic device 100 may receive a further instruction to select a section of content within a document in addition to or other than the first document. For example, the electronic device 100 may receive, via an input interface 144, to select a third section of second content within the second document. In response to the selection, the electronic device 201 may tag the selected third section of the second content with the first key term. Such a selection and tagging of the third section of the second content within the second document may be performed in the same manner as 202 and 204 respectively which are discussed above. Accordingly, multiple sections within different documents may be selected and tagged with the same first key term.

At 210, the electronic device 100 may populate a first summary document with the tagged first section of the first content and the tagged second section of the first content based on the first key term. That is, a document different than the first document (and the second document) is filled with sections associated with the first key term. In at least some example embodiments, in populating the first summary document, the electronic device 100 may search the content of the first document for all sections tagged with the first key term. Sections that are identified to be tagged with the first key term are then copied to populate a first summary document. For example, the first section and the second section that are tagged with the first key term may be identified when the electronic device 100 searches the first content within the first document for the associated first key term. The identified first section and second section are then copied to populate the first summary document. In at least some example embodiments, where only the first section of the first content within the first document is tagged with the first key term (and not the second section), the electronic device 100 may populate the first summary document with only the first section. Accordingly, any sections that have been tagged with the first key term are searched, identified and copied to populate the first summary document.

In at least some example embodiments, where a plurality of sections within a plurality of documents are tagged with the same key term, the electronic device 100 may populate the first summary document with all of the sections within the plurality of documents based on the key term. For example, in at least some example embodiments, if a third section of second content within a second document is selected and tagged with the first key term, in addition to the first section of the first content (and, in at least some example embodiments, also the second section of the first content) within the first document being selected and tagged with the first key term; the electronic device 100 may populate the first summary document with the tagged first section of the first content (and, in at least some example embodiment, also the tagged second section of the first content) within the first document and the tagged third section of the second content within the second document based on the first key term. For example, the electronic device 100 may search the first content within the first document and the second content within the second document for any sections that are tagged with the first key term. The identified first section (and, in at least some example embodiments, also the second section) and the third section that are associated with the first key term are then copied to populate the first summary document.

In at least some example embodiments, populating includes associating the tagged section within the first summary document to a link to the first document (or the second document). That is, the populated tagged sections within the first summary document may be associated with a link to the original documents that included these sections. For example, the tagged first section and the tagged second in the first summary document may be associated with a link to the first document, and the third section in the first summary document may be associated with a link to the second document. By providing links to the original documents from which sections were selected, tagged and populated, a user may access the original documents from the summary documents. For example, in at least some example embodiments, the tagged first section within the first summary document may be associated with a selectable interface element that links to the first document. After receiving selection of the interface element (for example, via an input interface 144), the electronic device 100 may retrieve the first document (for example, from the location of storage of the first document) and may display the first document on the display 146 of the electronic device 100.

In at least some example embodiments, a link (that each of the tagged sections is associated with) may include the address of the location of storage of the first document (or the second document). As mentioned above, the first document (and the second document) may be stored on the electronic device 100 (for example, in the memory 150 of the electronic device 100), another electronic device, system and/or server. Accordingly, the link may include the address of the corresponding device and/or the database or data store within the device that stores the first document (or the second document).

In at least some example embodiments, the populating function may be performed in response to receiving an instruction via the input interface 144. For example, a user of the electronic device 100 may input a command to search for all sections within documents (for example, the first document and/or the second document) that are tagged with the first key term. In response, the electronic device 100 may populate a first summary document with the tagged first section, second section and third section that are all associated with the first key term.

It will be appreciated that in at least some example embodiments, a different document (i.e. the first summary document) than the first (or second document) may not populated. Instead, the populating function may be performed within the same first document (and/or second document). For example, a portion within the first document (and/or second document) may be populated with the tagged first section.

As mentioned above, in at least some example embodiments, the selection and tagging functions may be performed for a plurality of key terms, and not only one key term. One such example embodiment is illustrated with reference to FIG. 3 which illustrates another example method 300 of tagging a document. In at least some example embodiments, the electronic device 100 may be configured to perform the method 300 of FIG. 3. In at least some example embodiments, the processor 120 of the electronic device 100 may be configured to perform the method 300 of FIG. 3. One or more applications 156 or modules on the electronic device 100 may contain computer readable instructions which cause the processor 120 of the electronic device 201 to perform the method 300 of FIG. 3. In at least some example embodiments, the word processor application 158 stored in memory 150 of the electronic device 100 is configured to perform the method 300 of FIG. 3. More specifically, the word processor application 158 may contain computer readable instructions which, when executed, cause the processor 120 to perform the method 300 of FIG. 3.

It will be appreciated that the method 300 of FIG. 3 may, in at least some example embodiments, be fully or partially provided by other software applications or modules apart from those specifically discussed above, such as, the operating system 223. Accordingly, any features which are referred to as being performed by the electronic device 201 may be performed by any one or more of the software applications 225 or modules referred to above or other software modules.

The method 300 includes, at 202, receiving, via an input interface 144, an instruction to select a first section of first content within a first document; at 204, tagging the selected first section of the first content with a first key term; and at 206, receiving, via an input interface 144, an instruction to select the second section of the first content within the first document. 202, 204 and 206 are discussed in greater detail above with reference to FIG. 2.

At 302, the electronic device 100 tags the selected second section of the first content with a second key term. That is, the second section is instead tagged with a key term that is different than the first key term. For example, the first section may be tagged with the first key term “Cause of Action A” and the second section may be tagged with the second key term “Cause of Action B”. Accordingly, the first document may include sections that are tagged with different key terms. It will be appreciated that the tagging of 302 may be performed in the same manner as 204 which is discussed in greater detail above with reference to FIG. 2.

In at least some example embodiment, the tagging with different key terms may be performed for multiple documents. For example, in at least some example embodiments, the electronic device 100 may, in addition to or instead of, receive, via an input interface 144, an instruction to select a fourth section of the second content within the second document; and after selection, tag the selected fourth section with the second key term. Accordingly, in such example embodiments, sections within the first document and the second document may be tagged with the first key term and the second key term. For example, the first section within the first document and the third section within the second document may be tagged with the first key term, and the second section within the first document and the fourth section within the second document may be tagged with the second key term.

At 304, the electronic device 100 may populate a second summary document with the tagged second section of the first content based on the second key term. That is, a second summary document (which is different than the first summary document) is populated with sections that are tagged with the second key term. For example, in at least some example embodiments, in populating the second summary document, the electronic device 100 may search the content of the first document for all sections tagged with the second key term. Sections that are identified to be tagged with the second key term are then copied to populate a second summary document. For example, the second section that is tagged with the second key term may be identified, and copied to populate the second summary document.

In at least some example embodiments, where sections in multiple documents are tagged with the second key term, the electronic device 100 may populate the second summary document with all the sections that are tagged with the second key. For example, the electronic device 100 may search the content in multiple documents (for example, the first document and the second document) for all sections that are tagged with the second key term. Identified sections are then copied to populate the second summary document. For example, if the second section of the first content within the first document and the fourth section of the second content within the second document are tagged with the second key term, the electronic device 100 populates the second summary document with the second section and the fourth section based on the second key term. Similarly, if only the fourth section of the second content within the second document is tagged with the second key term, the electronic device 100 populates the second summary document with only the fourth section based on the second key term.

It will be appreciated that the populating of 304 may be performed in the same manner as 210 which is discussed in greater detail above with reference to FIG. 2.

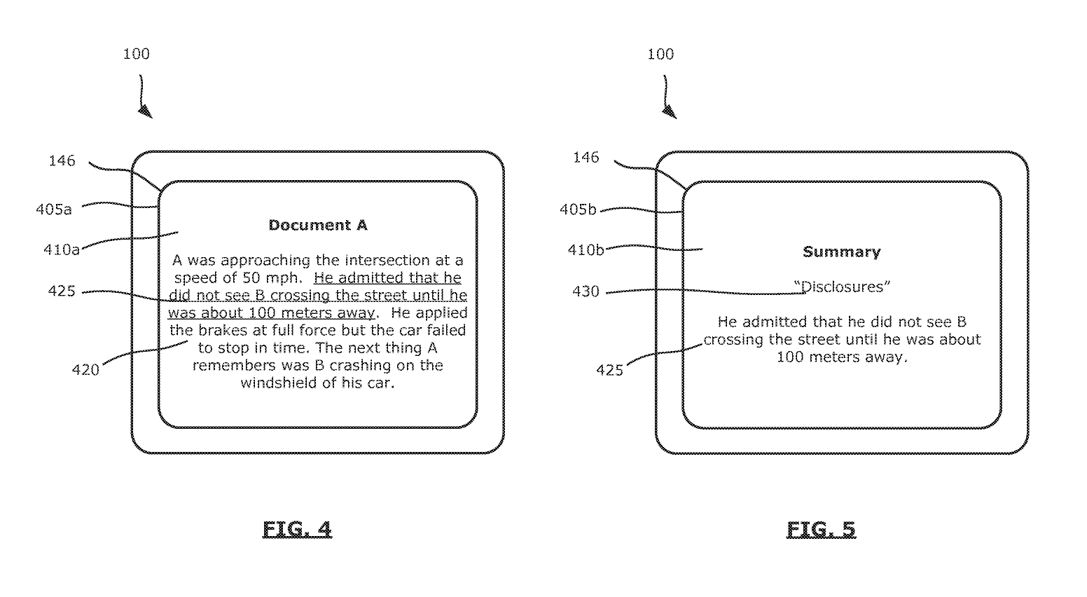

Example documents will now be discussed with reference to FIGS. 4 and 5. FIG. 4 shows an example display page 405a of a document on a display 146 of an example electronic device 100. The example electronic device 100 may be of the type described above with reference to FIGS. 1 to 3. In at least some example embodiments, the document is a first document 410a. The first document 410a includes first content 420. In the illustrated example embodiment, a first section 425 of the first content 420 is selected (for example, the portion “He admitted that he did not see B until he was 100 meters away” is selected). The selection may be performed in response to the electronic device 100 receiving an instruction via an associated input interface 144. The selected first section 425 is shown to be graphically altered (for example, underlined) to indicate that it has been selected.

In at least some example embodiments, the selected first section 425 is then tagged with a key term and another document is populated with the tagged first section 425 based on the key term. Reference is next made to FIG. 5 which shows such an illustration. More particularly, FIG. 5 illustrates another example display page 405b of another document on the display 146 of the example electronic device 100.

As mentioned above, in at least some example embodiments, the another display page 405b of another document is displayed after the tagging and populating functions are performed on the document of FIG. 4. For example, the another document is a first summary document 410b. The first summary document 410b is populated with the selected and tagged first section 425 of the first content 420 based on a first key term 430 (for example, the key term “disclosures”). That is, the selected first section 425 is tagged with the first key term 430, and the first summary document 410b is then populated with the tagged first section 425 based on the first key term.

It will be appreciated that the present application is also directed to apparatus such an electronic device. More specifically, the electronic device includes components (such as hardware and/or software) for performing features of the described methods. Furthermore, an article of manufacture for use with the apparatus, such as a computer readable storage medium having stored thereon computer readable program instructions, which when executed may cause the apparatus to perform features of the described methods. It will be appreciated that the computer readable medium may include any medium capable of storing instructions which may be executed by a computer, and may include an optical disc such as a compact disc (CD), a universal serial bus (USB) flash drive, a random access memory (RAM), a read only memory (ROM), an erasable programmable read only memory (EPROM), etc.

It will be appreciated that the various embodiments provided are simply example embodiments and are not meant to limit the scope of this application. Different variations will be apparent to those ordinarily skilled in the art with such variations failing with the intended scope of the present application.

1. A method implemented by a processor of an electronic device, the electronic device including an input interface, the method comprising:
receiving, via the input interface, an instruction to select a first section of first content within a first document; and
tagging the selected first section of the first content with a first key term.

2. The method of claim 1, further comprising:
populating a first summary document with the tagged first section of the first content based on the first key term.

3. The method of claim 1, further comprising:
receiving, via the input interface, an instruction to select a second section of the first content within the first document; and
tagging the selected second section of the first content with the first key term.

4. The method of claim 3, further comprising:
populating the first summary document with the tagged first section of the first content and the tagged second section of the first content based on the first key term.

5. The method of claim 1, further comprising:
Receiving, via the input interface, an instruction to select the second section of the first content within the first document; and
tagging the selected second section of the first content with a second key term.

6. The method of claim 5, further comprising:
populating a second summary document with the tagged second section of the first content based on the second key term.

7. The method of claim 1, further comprising:
Receiving, via the input interface, an instruction to select a fourth section of second content within a second document; and
tagging the selected fourth section of the second content with the second key term.

8. The method of claim 7, further comprising:
populating the second summary document with the tagged fourth section of the second content based on the second key term.

9. The method of claim 1, further comprising:
receiving an instruction via the input interface to select the third section of the second content within the second document; and
tagging the selected third section of the second content with the first key term.

10. The method of claim 9, further comprising:
populating the first summary document with the tagged first section of the first content and the tagged third section of the second content based on the first key term.

11. The method of claim 2, wherein populating includes associating the tagged first section within the first summary document to a link or pointer to the first document.

12. The method of claim 1, wherein the first key term is received via the input interface associated with the electronic device.

13. The method of claim 1, wherein the electronic device includes an output interface, and the method further comprising: prior to tagging, presenting a confirmation via the output interface to tag the selected first section, and wherein said tagging is performed when the confirmation is received via the input interface.

14. An electronic device comprising:
a memory; and
a processor coupled to the memory, the processor configured to:
receive an instruction via the input interface to select a first section of first content within a first document; and
tag the selected first section of the first content with a first key term.

15. The electronic device of claim 14, wherein the processor is further configured to:
populate a first summary document with the tagged first section of the first content based on the first key term.

16. The electronic device of claim 14, wherein the processor is further configured to:
receive an instruction via the input interface to select a second section of the first content within the first document; and
tag the selected second section of the first content with the first key term.

17. The electronic device of claim 16, wherein the processor is further configured to:
populate the first summary document with the tagged first section of the first content and the tagged second section of the first content based on the first key term.

18. The electronic device of claim 14, wherein the processor is further configured to:
receive an instruction via the input interface to select the second section of the first content within the first document; and
tag the selected second section of the first content with a second key term.

19. The electronic device of claim 18, wherein the processor is further configured to:
populate a second summary document with the tagged second section of the first content based on the second key term.

20. A computer readable storage medium comprising computer executable instructions, the computer executable instructions including instructions for:
receiving an instruction via the input interface to select a first section of first content within a first document; and
tagging the selected first section of the first content with a first key term.
